(19) United States
(12) Patent Application Publication
(10) Pub. No.: US 2024/0177269 A1
(43) Pub. Date: May 30, 2024

(54) METHOD OF LOCAL IMPLICIT NORMALIZING FLOW FOR ARBITRARY-SCALE IMAGE SUPER-RESOLUTION, AND ASSOCIATED APPARATUS

(71) Applicant: MEDIATEK INC., Hsin-Chu (TW)

(72) Inventors: Jie-En Yao, Hsinchu City (TW); Yi-Chen Lo, Hsinchu City (TW); Li-Yuan Tsao, Hsinchu City (TW); Shou-Yao Tseng, Hsinchu City (TW); Chia-Che Chang, Hsinchu City (TW); Chun-Yi Lee, Hsinchu City (TW)

(73) Assignee: MEDIATEK INC., Hsin-Chu (TW)

(21) Appl. No.: 18/518,614

(22) Filed: Nov. 24, 2023

Related U.S. Application Data
(60) Provisional application No. 63/384,971, filed on Nov. 25, 2022.

(51) Int. Cl. G06T 3/40

(52) U.S. Cl. CPC G06T 3/4053; G06T 3/4046

(57) ABSTRACT

A method of local implicit normalizing flow for arbitrary-scale image super-resolution, an associated apparatus and an associated computer-readable medium are provided. The method applicable to a processing circuit may include: utilizing the processing circuit to run a local implicit normalizing flow framework to start performing arbitrary-scale image super-resolution with a trained model of the local implicit normalizing flow framework according to at least one input image, for generating at least one output image, where a selected scale of the output image with respect to the input image is an arbitrary-scale; and during performing the arbitrary-scale image super-resolution with the trained model, performing prediction processing to obtain multiple super-resolution predictions for different locations of a predetermined space in a situation where a same non-super-resolution input image among the at least one input image is given, in order to generate the at least one output image.

### CROSS REFERENCE TO RELATED APPLICATIONS

This application claims the benefit of U.S. Provisional Application No. 63/384,971, filed on Nov. 25, 2022. The content of the application is incorporated herein by reference.

### BACKGROUND

The present invention is related to image processing, and more particularly, to a method of local implicit normalizing flow for arbitrary-scale image super-resolution, an associated apparatus and an associated computer-readable medium.

According to the related art, flow-based methods have demonstrated promising results in addressing the ill-posed nature of super-resolution (SR) by learning the distribution of high-resolution (HR) images with the normalizing flow. However, these methods can only perform a predefined fixed-scale SR, limiting their potential in real-world applications. Meanwhile, arbitrary-scale SR has gained more attention and achieved great progress. Nonetheless, previous arbitrary-scale SR methods ignore the ill-posed problem and train the model with per-pixel absolute (L1) loss, leading to blurry SR outputs. Thus, a novel method and associated architecture are needed for solving the problems without introducing any side effect or in a way that is less likely to introduce a side effect.

### SUMMARY

It is an objective of the present invention to provide a method of local implicit normalizing flow for arbitrary-scale image super-resolution, and associated apparatus such as a processing circuit (e.g., an image processing circuit) within an electronic device, as well as an associated computer-readable medium, in order to solve the above-mentioned problems.

At least one embodiment of the present invention provides a method of local implicit normalizing flow for arbitrary-scale image super-resolution, where the method can be applied to a processing circuit within an electronic device. For example, the method may comprise: utilizing the processing circuit to run a local implicit normalizing flow framework to start performing arbitrary-scale image super-resolution with a trained model of the local implicit normalizing flow framework according to at least one input image, for generating at least one output image, wherein a selected scale of the at least one output image with respect to the at least one input image is an arbitrary-scale; and during performing the arbitrary-scale image super-resolution with the trained model, performing prediction processing to obtain multiple super-resolution predictions for different locations of a predetermined space in a situation where a same non-super-resolution input image among the at least one input image is given, in order to generate the at least one output image.

At least one embodiment of the present invention provides an apparatus that operates according to the above method, where the apparatus may comprise at least the processing circuit within the electronic device. According to some embodiments, the apparatus may comprise the whole of the electronic device.

At least one embodiment of the present invention provides a computer-readable medium related to the above method, where the computer-readable medium may store a program code which causes the processing circuit to operate according to the method when executed by the processing circuit.

It is an advantage of the present invention that, the present invention method, as well as the associated apparatus such as the processing circuit and the electronic device, can perform arbitrary-scale image super-resolution without any related art problem. More particularly, in the present invention, “Local Implicit Normalizing Flow” (LINF) can be proposed as a unified solution to the above problems of the related art. LINF models the distribution of texture details under different scaling factors with normalizing flow. Thus, LINF can generate photorealistic HR images with rich texture details in arbitrary scale factors. In addition, LINF has been evaluated with extensive experiments to show that LINF achieves the state-of-the-art perceptual quality compared with arbitrary-scale SR methods of the related art. Additionally, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates, in the upper half part thereof, a control scheme of a method of local implicit normalizing flow (LINF) for arbitrary-scale image super-resolution according to an embodiment of the present invention, where a blurry issue of previous arbitrary-scale SR approaches may be illustrated in the lower half part of FIG. 1 for better comprehension.

FIG. 2 is a diagram illustrating a LINF framework involved with the method according to an embodiment of the present invention.

FIG. 3 illustrates the trade-off between PSNR and LPIPS with varying sampling temperatures.

FIG. 4 is a diagram illustrating an electronic device involved with the method according to an embodiment of the present invention.

FIG. 5 is a flowchart of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Arbitrary-scale image super-resolution (SR) has gained increasing attention recently due to its tremendous application potential. However, this field of study suffers from two major challenges. First, SR aims to reconstruct high-resolution (HR) image from a low-resolution (LR) counterpart by recovering the missing high-frequency information. This process is inherently ill-posed since the same LR image can yield many plausible HR solutions. Second, prior deep learning based SR approaches typically apply upsampling with a pre-defined scale in their network architectures, such as squeeze layer, transposed convolution, and sub-pixel convolution. Once the upsampling scale is determined, they are unable to further adjust the output resolutions without modifying their model architecture. This causes inflexibility in real-world applications. As a result, discovering a way to perform arbitrary-scale SR and produce photo-realistic HR images from an LR image with a single model has become a crucial research direction.

According to some embodiments of the present invention, SR may be formulated as a problem of learning the distribution of local texture patch. With the learned distribution, the present invention method and apparatus can perform super-resolution by generating the local texture separately for each non-overlapping patch in the HR image.

With the new problem formulation, the present invention can provide Local Implicit Normalizing Flow (LINF) as the solution. Specifically, a coordinate conditional normalizing flow models the local texture patch distribution, which is conditioned on the LR image, the central coordinate of local patch, and the scaling factor. To provide the conditional signal for the flow model, the present invention method and apparatus can use the local implicit module to estimate Fourier information at each local patch. LINF excels the previous flow-based SR methods with the capability to upscale images with arbitrary scale factors. Different from prior arbitrary-scale SR methods of the related art, LINF explicitly addresses the ill-posed issue by learning the distribution of local texture patch.

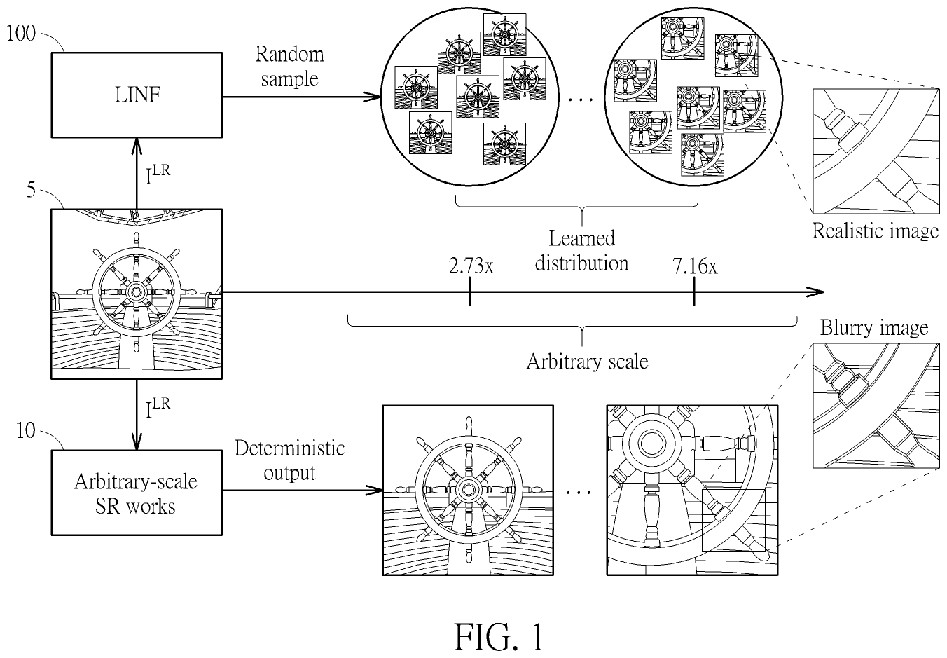

FIG. 1 illustrates, in the upper half part thereof, a control scheme of a method of local implicit normalizing flow (LINF) for arbitrary-scale image super-resolution according to an embodiment of the present invention, where a blurry issue of previous arbitrary-scale SR approaches may be illustrated in the lower half part of FIG. 1 for better comprehension. LINF models the distribution of texture details in HR images at arbitrary scales (e.g., 2.73×, 7.16× or any other scale with floating number). Therefore, unlike the related art methods (or the arbitrary-scale SR works 10) that tend to produce blurry images, LINF (or the LINF framework 100) is able to generate arbitrary-scale HR images with rich and photo-realistic textures. As shown in FIG. 1, hence, LINF can generate HR images with rich and reasonable details instead of the over-smoothed ones. Furthermore, LINF can address the issue of unpleasant generative artifacts, a common drawback of generative models, by controlling the sampling temperature. Specifically, the sampling temperature in normalizing flow controls the trade-off between PSNR (or fidelity-oriented metric) and LPIPS (or perceptual-oriented metric). The associated contributions of the present invention may comprise:
1. the present invention provides the novel LINF framework 100 (labeled “LINF” for brevity) that leverages the advantages of a local implicit module and normalizing flow, where LINF is the first framework that employs normalizing flow to generate photo-realistic HR images at arbitrary scales, for example, according to any LR image 5;
2. the present invention can validate the effectiveness of LINF to serve as a unified solution for the ill-posed and arbitrary-scale challenges in SR via quantitative and qualitative evidences; and
3. the trade-offs between the fidelity- and perceptual-oriented metrics have been examined to show that LINF does yield a better trade-off than the SR approaches of the related art.

### 1. Methodology

In this section, the SR problem concerned by the present invention will be formally defined first, and an overview of the proposed framework will be provided. Then, the details of its modules can be elaborate on, followed by a discussion of the associated training scheme.

Problem definition. Given an LR image I^{LR}∈R^{H×W×3} and an arbitrary scaling factor s, the objective of this work is to generate an HR image I^{HR}∈R^{sH×sW×3}, where H and W represent the height and width of the LR image. Different from previous works, SR can be formulated as a problem of learning the distributions of local texture patches by normalizing flow, where ‘texture’ is defined as the residual between an HR image and the bilinearly upsampled LR counterpart. These local texture patches are constructed by grouping sH×SW pixels of I^{HR} into h×w non-overlapping patches of size n×n pixels, where h=[sH/n], w=[sW/n]. The target distribution of a local texture patch m_{i,j} to be learned can be formulated as a conditional probability distribution p(m_{i,j}|I^{LR}, x_{i,j}, s), where (i, j) represent the patch index, and x_{i,j}∈R² denotes the center coordinate of m_{i,j}. The predicted local texture patches are aggregated together to form I^{HR}ₜₑₓₜᵤᵣₑ∈R^{sH×sW×3}, which is then combined with a bilinearly upsampled image I^{LR}_{↑}∈R^{sH×sW×3} via element-wise addition to derive the final HR image I^{HR}.

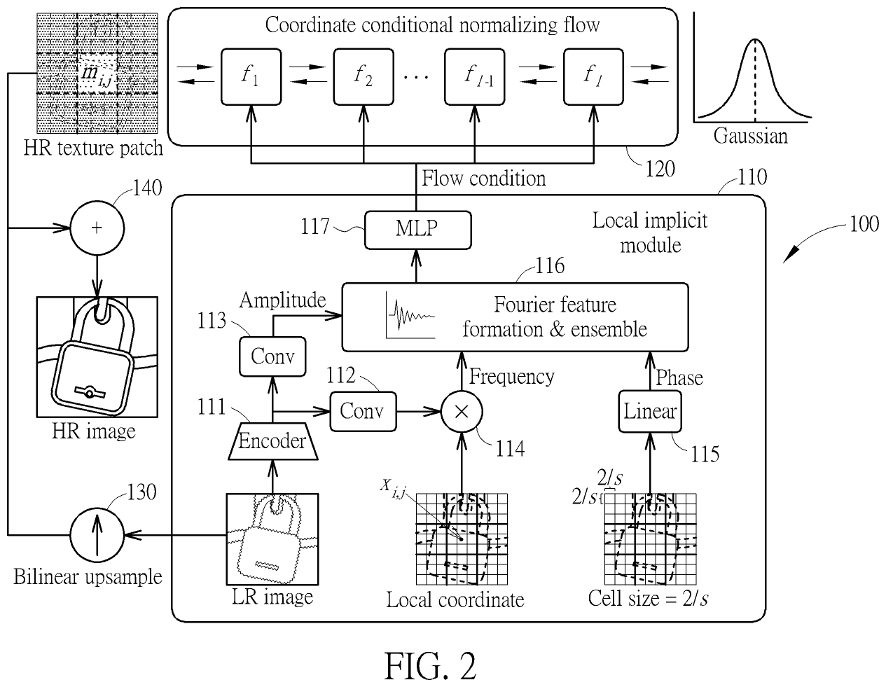

Overview. FIG. 2 is a diagram illustrating the LINF framework 100 involved with the method according to an embodiment of the present invention. The LINF framework 100 may comprise two modules: (1) a local implicit module 110 (or “the local implicit model”), and (2) a coordinate conditional normalizing flow 120 (or simply “the flow model” hereafter). The former generates the conditional parameters for the latter, enabling LINF to take advantages of both local implicit neural representation and normalizing flow. Specifically, the former first derives the local Fourier features from I^{LR}, x_{i,j}, and s. The proposed Fourier feature ensemble is then applied on the extracted features. Finally, given the ensembled feature, the latter utilizes an multilayer perceptron (MLP) 117 (or “the MLP module”) to generate the parameters for the flow model to approximate p(m_{i,j}| I^{LR}, x_{i,j}, s). Their details and the training strategy can be elaborated on next.

For example, the local implicit model first encodes an LR image, a local coordinate and a cell into Fourier features, which is followed by the MLP 117 for generating the conditional parameters (labeled “Flow condition” for better comprehension). The flow model then leverages these parameters to learn a bijective mapping between a local texture patch space and a latent space.

### 1.1. Coordinate Conditional Normalizing Flow

Normalizing flow approximates a target distribution by learning a bijective mapping between a target space and a latent space, such as the bijective mapping:

f_{θ}=f₁○f₂○ . . . ○fₗ

where f_{θ} denotes a flow model parameterized by θ, and f₁ to fₗ represent l invertible flow layers. In LINF, the flow model approximates such a mapping between a local texture patch distribution p(m_{i,j}|I^{LR}, x_{i,j}, s) and a Gaussian distribution p_{z}(z) as:

$${m}_{i , j} = {h}_{0} {⇄}_{{f}_{1}^{- 1}}^{{f}_{1}} {h}_{1} {⇄}_{{f}_{2}^{- 1}}^{{f}_{2}} … {h}_{k - 1} {⇄}_{{f}_{k}^{- 1}}^{{f}_{k}} {h}_{k} … {⇄}_{{f}_{l}^{- 1}}^{{f}_{l}} {h}_{l} = 𝓏 , \qquad ( 1 )$$

where z˜N(0, τ) is a Gaussian random variable, t is a temperature coefficient, hₖ=fₖ(hₖ₋₁), k∈[1, . . . , l], denotes a latent variable in the transformation process, and fₖ⁻¹ is the inverse of fₖ. By applying the change of variable technique, the mapping of the two distributions p(m_{i,j}|I^{LR}, x_{i,j}, s) and p_{z}(z) can be expressed as follows:

$$log {p}_{θ} ( {m}_{i , j} \vert {I}^{LR} , {x}_{i , j} , 𝓈 ) = log {p}_{𝓏} ( 𝓏 ) + {\sum }_{k = 1}^{l} log \vert det \frac{\partial {f}_{k} ( {h}_{k} - 1 )}{\partial {h}_{k - 1}} \vert . \qquad ( 2 )$$

The term in the summation shown above, i.e.,

$$log \vert det \frac{\partial {f}_{k} ( {h}_{k} - 1 )}{\partial {h}_{k - 1}} \vert ,$$

is the logarithm of the absolute Jacobian determinant of fₖ. As I^{HR}ₜₑₓₜᵤᵣₑ (and hence, the local texture patches) can be directly derived from I^{HR}, I^{LR}, and s during the training phase, the flow model can be optimized by minimizing the negative log-likelihood loss. During the inference phase, the flow model is used to infer local texture patches by transforming sampled z's with f⁻¹. Note that the values of t may be different during the training and the inference phases.

Implementation details. Since the objective of the flow model is to approximate the distributions of local texture patches rather than an entire image, it can be implemented with a relatively straightforward model architecture. For example, the flow model is composed of ten flow layers, each of which consists of a linear layer and an affine injector layer. Each linear layer k is parameterized by a learnable pair of weight matrix Wₖ and bias βₖ. The forward and inverse operations of the linear layer can be formulated as:

$$\begin{matrix}{h}_{k} = {𝒲}_{k} {h}_{k - 1} + {β}_{k} , & {h}_{k - 1} = {𝒲}_{k}^{- 1} ( {h}_{k} - {β}_{k} ) ,\end{matrix} \qquad ( 3 )$$

where Wₖ⁻¹ is the inverse matrix of Wₖ. The Jacobian determinant of a linear layer is simply the determinant of the weight matrix Wₖ. Since the dimension of a local texture patch is relatively small (i.e., n×n pixels), calculating the inverse and determinant of the weight matrix Wₖ is feasible.

On the other hand, the affine injector layers are employed to enable two conditional parameters α and φ (or “ϕ”) generated from the local implicit module 110 to be fed into the flow model. The incorporation of these layers allows the distribution of a local texture patch m_{i,j} to be conditioned on I^{LR}, x_{i,j}, and s. The conditional parameters are utilized to perform element-wise shifting and scaling of latent h, expressed as:

$$\begin{matrix}{h}_{k} = {α}_{k} ⊙ {h}_{k - 1} + {ϕ}_{k} , & {h}_{k - 1} = ( {h}_{k} - {ϕ}_{k} ) / {α}_{k} ,\end{matrix} \qquad ( 4 )$$

where k denotes the index of a certain affine injector layer, and ⊙ represents element-wise multiplication. The log-determinant of an affine injector layer is computed as Σ log (αₖ), which sums over all dimensions of indices.

### 1.2. Local Implicit Module

The goal of the local implicit module 110 is to generate conditional parameters α and φ from the local Fourier features extracted from I^{LR}, x_{q}, and s. This can be formulated as:

$$α , ϕ = {g}_{Φ} ( {E}_{Ψ} ( {υ}^{*} , {x}_{q} - {x}^{*} , c ) ) , \qquad ( 5 )$$

where g_{Φ} (or “g_{Φ}”) represents the parameter generation function implemented as an MLP, x_{q} is the center coordinate of a queried local texture patch in I^{HR}, v* is the feature vector of the 2D LR coordinate x* which is nearest to x_{q} in the continuous image domain (see Y. Chen, S. Liu, and X. Wang, “Learning continuous image representation with local implicit image function”, Proc. IEEE Conf. on Computer Vision and Pattern Recognition (CVPR), pages 8628-8638, 2021; “Chen” hereinafter), c=2/s denotes the cell size, and x_{q}-x* is known as the relative coordinate. Following J. Lee and K. H. Jin, “Local texture estimator for implicit representation function”, Proc. IEEE Conf. on Computer Vision and Pattern Recognition (CVPR), pages 1929-1938, 2022, the local implicit module 110 employs a local texture estimator E_{Ψ} to extract the Fourier features given any arbitrary x_{q}. This function can be expressed as follows:

$${E}_{Ψ} ( {υ}^{*} , {x}_{q} - {x}^{*} , c ) : A ⊙ [ \begin{matrix}cos ( π F ( {x}_{q} - {x}^{*} ) + P ) \\ sin ( π F ( {x}_{q} - {x}^{*} ) + P )\end{matrix} ] , \qquad ( 6 )$$

where ⊙ denotes element-wise multiplication, and A, F, P are the Fourier features extracted by three distinct functions:

$$A = {E}_{a} ( {υ}^{*} ) , F = {E}_{f} ( {υ}^{*} ) , P = {E}_{p} ( c ) , \qquad ( 7 )$$

where Eₐ, E_{f}, and Eₚ are the functions for estimating amplitudes, frequencies, and phases, respectively. In the present invention, the former two can be implemented with convolutional layers (e.g., the convolutional layers modules 112 and 113), while the latter can be implemented as an MLP. Given the number of frequencies to be modeled as K, the dimensions of these features are A∈R^{2K}, F∈R^{K×2}, and P∈R^{K}.

Fourier feature ensemble. To avoid color discontinuity when two adjacent pixels select two different feature vectors, a local ensemble method was proposed in Chen to allow RGB values to be queried from the nearest four feature vectors around x_{q} and fuse them with bilinear interpolation. If this method is employed, the forward and inverse transformation of the flow model f_{θ} would be expressed as follows:

$$𝓏 = {\sum }_{j ∈ Υ} {w}_{j} * {f}_{θ} ( patch ; {g}_{Φ} ( {E}_{Ψ} ( {υ}_{j} , {x}_{q} - {x}_{j} , c ) ) ) \qquad ( 8 )$$

$$patch = {\sum }_{j ∈ Υ} {w}_{j} * {f}_{θ}^{- 1} ( 𝓏 ; {g}_{Φ} ( {E}_{Ψ} ( {υ}_{j} , {x}_{q} - {x}_{j} , c ) ) ) ,$$

where γ is the set of four nearest feature vectors, and wⱼ is the derived weight for performing bilinear interpolation.

Albeit effective, local ensemble requires four forward passes of the local texture estimator E_{Ψ}, the parameter generator g_{Φ}, and the flow model f_{θ}. To deal with this drawback, the local implicit module 110 employs a different approach named “Fourier feature ensemble” to streamline the computation. Instead of directly generating four RGB samples and then fuse them in the image domain, it is proposed in the present invention to ensemble the four nearest feature vectors right after the local texture estimator E_{Ψ}. More specifically, these feature vectors are concatenated to form an ensemble:

$$κ = concat ( \{ {w}_{j} * {E}_{Ψ} ( {υ}_{j} , {x}_{q} - {x}_{j} , c ) , ∀ j ∈ Υ \} ) ,$$

in which each feature vector is weighted by wⱼ to allow the model to focus more on closer feature vectors. The proposed technique requires g_{Φ} and f_{θ} to perform only one forward pass to capture the same amount of information as the local ensemble method and deliver same performance. It is expressed as:

$$𝓏 = {f}_{θ} ( patch ; {g}_{Φ} ( κ ) ) ; patch = {f}_{θ}^{- 1} ( 𝓏 ; {g}_{Φ} ( κ ) ) . \qquad ( 9 )$$

### 1.3. Training Scheme

LINF employs a two-stage training scheme. In the first stage, it is trained only with the negative log-likelihood loss Lₙₗₗ. In the second stage, it is fine-tuned with an additional L1 loss on predicted pixels Lₚᵢₓₑₗ, and the VGG perceptual loss on the patches predicted by the flow model L_{vgg}. The total loss function L can be formulated as follows:

$$L = {λ}_{1} {L}_{nll} ( {patch}_{gt} ) + {λ}_{2} {L}_{pixel} ( {patch}_{gt} , {patch}_{τ = 0} ) + {λ}_{3} {L}_{υ gg} ( {patch}_{gt} , {patch}_{τ = 0.8} ) , \qquad ( 10 )$$

where λ₁, λ₂, and λ₃ are the scaling parameters, patch_{gt} denotes the ground-truth local texture patch, and (patch_{τ=0}, patch_{τ=0.8}) represent the local texture patches predicted by LINF with temperature τ=0 and T=0.8, respectively.

### 2. Fidelity-Perception Trade-Off

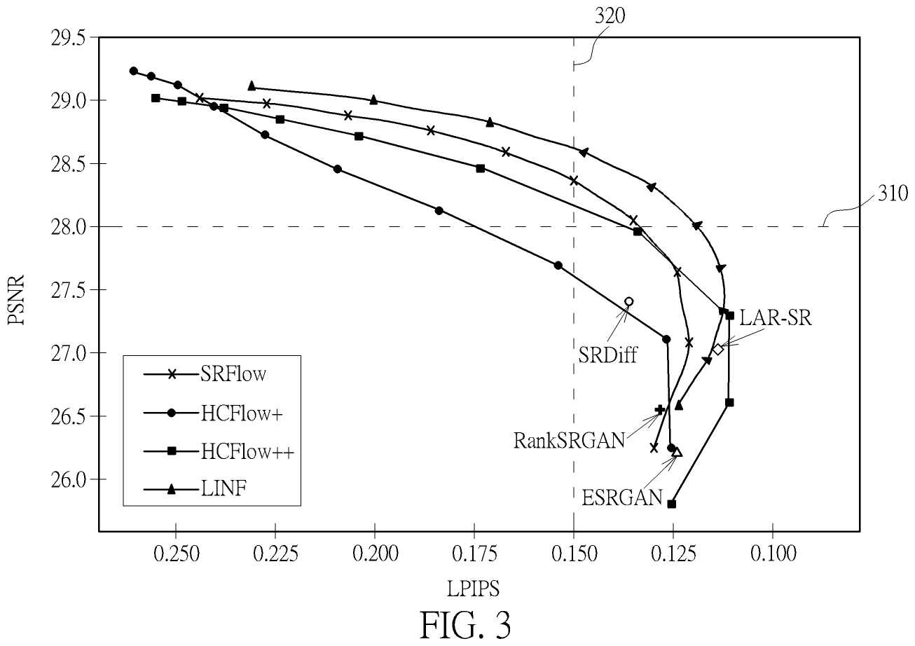

FIG. 3 illustrates the trade-off between PSNR and LPIPS with varying sampling temperatures τ. The sampling temperature increases from the top left corner (τ=0.0) to the bottom right corner (τ=1.0). The x-axis is reversed for improved visualization.

Since SR presents an ill-posed problem, achieving optimal fidelity (i.e., the discrepancy between reconstructed and ground truth images) and perceptual quality simultaneously presents a considerable challenge. As a result, the trade-off between fidelity and perceptual quality necessitates an in-depth exploration. By leveraging the inherent sampling property of normalizing flow, it is feasible to plot the trade-off curve between PSNR (fidelity) and LPIPS (perception) for flow-based models by adjusting temperatures, as depicted in FIG. 3. This trade-off curve reveals two distinct insights. First, when the sampling temperature escalates from low to high (i.e., from the top left corner to the bottom right corner), the flow models tend to exhibit lower PSNR but improved LPIPS. However, beyond a specific temperature threshold, both PSNR and LPIPS degrade as the temperature increase. This suggests that a higher temperature does not guarantee enhanced perceptual quality, as flow models may generate noisy artifacts. Nevertheless, through appropriate control of the sampling temperature, it is possible to select the preferred trade-off between fidelity and visual quality to produce photo-realistic images. Second, FIG. 3 illustrates that the trade-off Pareto front of LINF consistently outperforms those of the prior flow-based methods of the related art except at the two extreme ends. This reveals that given an equal PSNR (e.g., a predetermined PSNR value 310 such as 28.0), LINF exhibits superior LPIPS. Conversely, when LPIPS values are identical (e.g., a predetermined LPIPS value 320 such as 0.150), LINF demonstrates improved PSNR. This finding underscores that LINF attains a more favorable balance between PSNR and LPIPS in comparison to preceding techniques.

For better comprehension, the measurement result of LINF (or the LINF framework 100) as well as the respective measurement results of some related art methods (e.g., SRFlow, HCFlow+ and HCFlow++ which are two versions of HCFlow, SRDiff, LAR-SR, RankSRGAN and ESRGAN) may be illustrated as shown in FIG. 3, for indicating that the overall performance of LINF is higher than that of the related art, but the present invention is not limited thereto. According to some embodiments, the architecture of the LINF framework 100 and/or the configurations (e.g., the associated coefficients) thereof may vary, and the measurement result may vary correspondingly.

### 3. Conclusion

As shown above, a novel framework called LINF for arbitrary-scale SR is introduced, where LINF is the first approach to employ normalizing flow for arbitrary-scale SR. Specifically, SR is formulated as a problem of learning the distributions of local texture patches. For example, the coordinate conditional normalizing flow 120 can be utilized to learn the distribution, and the local implicit module 110 can be utilized to generate conditional signals. Through quantitative and qualitative experiments, it has been demonstrated that LINF can produce photo-realistic high-resolution images at arbitrary upscaling scales while achieving the optimal balance between fidelity and perceptual quality among all methods.

### 4. Associated Architecture

In the embodiment shown in FIG. 2, the LINF framework 100 may comprise multiple modules corresponding to different types of models, such as the local implicit module 110 and the coordinate conditional normalizing flow 120, as well as the bilinear upsample module 130 (or “the Bilinear upsample”) and the adder module 140 (respectively labeled “↑” and “+” for brevity), where the local implicit module 110 may comprise multiple sub-modules such as the encoder module 111, the convolutional layers modules 112 and 113, the multiplier module 114, the linear module 115, the Fourier feature formation and ensemble module 116 and the MLP module 117 (respectively labeled “Encoder”, “Conv”, “×”, “Linear”, “Fourier feature formation & ensemble” and “MLP” for brevity), but the present invention is not limited thereto. According to some embodiments, the architecture of the LINF framework 100 may vary. For example, most sub-modules among all sub-modules of the local implicit module 110, except the MLP module 117, may be regarded as the sub-modules of a frequency estimation module for performing frequency estimation. In this situation, the LINF framework 100 may comprise the frequency estimation module, the coordinate conditional normalizing flow 120, a hypernetwork module coupled between the frequency estimation module and the coordinate conditional normalizing flow 120, the bilinear upsample module 130 and the adder module 140, where the hypernetwork module may comprise the MLP module 117 and the sub-flows regarding the flow condition from the MLP module 117 to the coordinate conditional normalizing flow 120. For brevity, similar descriptions for these embodiments are not repeated in detail here.

According to some embodiments, the mapping operations of the coordinate conditional normalizing flow 120 along the directions indicated by the arrows illustrated therein may represent one-to-one mapping operations, with the conditional parameters α and φ being controllable by the local implicit module 110, where the rightward and the leftward mapping operations may correspond to the training and the inference of the LINF framework 100 (or the coordinate conditional normalizing flow 120), respectively. In addition, the coordinate conditional normalizing flow 120 may operate according to Equations (3) and (4), the MLP module 117 may operate according to Equation (5), the Fourier feature formation and ensemble module 116 may operate according to Equation (6), and the sub-modules (e.g., the convolutional layers module 112, the combination of the convolutional layers module 113 and the multiplier module 114, and the linear module 115) of the three sub-paths regarding the amplitude vector, the frequency vector, and the phase vector may operate according to Equations (7), respectively. More particularly, the convolutional layers module 112 of the sub-path regarding the amplitude vector (e.g. the amplitudes) may operate according to the first equation (i.e., A=Eₐ(v*)) among Equations (7), the combination of the convolutional layers module 113 and the multiplier module 114 of the sub-path regarding the frequency vector (e.g. the frequencies) may operate according to the second equation (i.e., F=E_{f}(v*)) among Equations (7), and the linear module 115 of the sub-path regarding the phase vector (e.g. the phases) may operate according to the third equation (i.e., P=Eₚ(c)) among Equations (7). Additionally, at least one portion of sub-modules among the multiple sub-modules of the local implicit module 110, such as the encoder module 111, the convolutional layers modules 112 and 113, the multiplier module 114 and the linear module 115, may be implemented by way of neural network layers within one or more artificial intelligence (AI) models. For brevity, similar descriptions for these embodiments are not repeated in detail here.

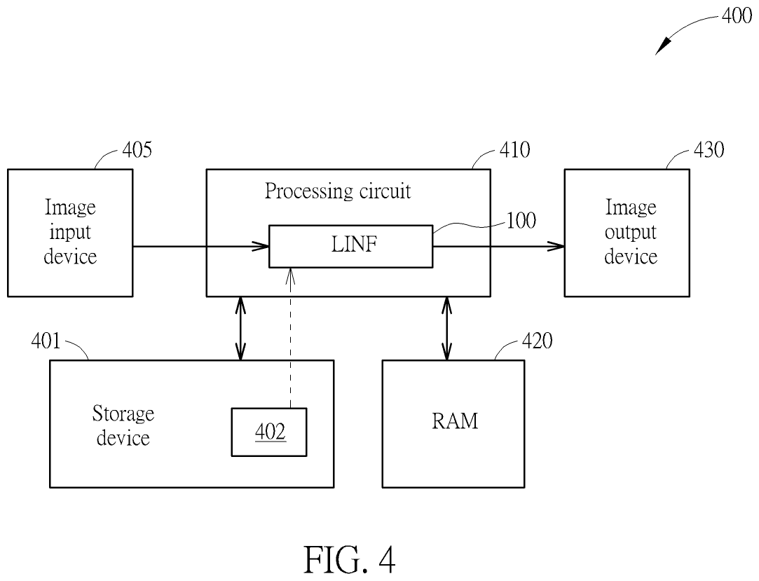

FIG. 4 is a diagram illustrating an electronic device 400 involved with the method according to an embodiment of the present invention. Examples of the electronic device 400 may include, but are not limited to: a personal computer (PC) such as a desktop computer and a laptop computer, a server, an all in one (AIO) computer, a tablet computer and a multifunctional mobile phone as well as a wearable device.

The electronic device 400 may comprise a processing circuit 410 that is capable of running the LINF framework 100 (labeled “LINF” for brevity), and may further comprise a computer-readable medium such as a storage device 401, an image input device 405, a random access memory (RAM) 420 and an image output device 430. The processing circuit 410 may be arranged to control operations of the electronic device 400. More particularly, the computer-readable medium such as the storage device 401 may be arranged to store a program code 402, for being loaded onto the processing circuit 410 to act as the LINF framework 100 running on the processing circuit 410. When executed by the processing circuit 410, the program code 402 may cause the processing circuit 410 to operate according to the method, in order to perform the associated operations of the LINF framework 100. For example, multiple program modules may run on the processing circuit 410 for controlling the operations of the electronic device 400, where the LINF framework 100 may be one of the multiple program modules, but the present invention is not limited thereto. In addition, the image input device 405 may be arranged to input or receive multiple input images, the RAM 420 may be arranged to temporarily store the multiple input images, the LINF framework 100 running on the processing circuit 410 may be arranged to process the multiple input images, and more particularly, perform SR processing on the multiple input images to generate multiple output images, and the image output device 430 may be arranged to output or display the multiple output images, but the present invention is not limited thereto. For example, the RAM 420 may be arranged to temporarily store the multiple input images and the multiple output images, and/or the storage device 401 may be arranged to store the multiple input images and the multiple output images.

In the above embodiment, the storage device 401 can be implemented by way of a hard disk drive (HDD), a solid state drive (SSD) and a non-volatile memory such as a Flash memory, the image input device 405 can be implemented by way of a camera, the processing circuit 410 can be implemented by way of at least one processor, the RAM 420 can be implemented by way of a dynamic random access memory (DRAM), and the image output device 430 can be implemented by way of a display device such as a liquid-crystal display (LCD) panel, an organic light-emitting diode (OLED) panel, etc., where the display device can be implemented as a touch-sensitive panel, but the present invention is not limited thereto. According to some embodiments, the architecture of the electronic device 400 and/or the components therein may vary.

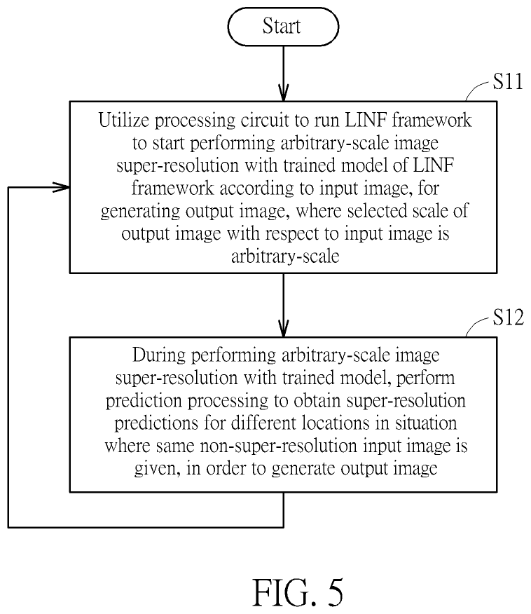

FIG. 5 is a flowchart of the method according to an embodiment of the present invention. The method can be applied to the electronic device 400 as well as the processing circuit 410 within the electronic device 400.

In Step S11, the electronic device 400 may utilize the processing circuit 410 to run the LINF framework 100 to start performing the arbitrary-scale image super-resolution with the trained model of the LINF framework 100 according to at least one input image (e.g., at least one image among the multiple input images), for generating at least one output image (e.g., at least one image among the multiple output images), where a selected scale (e.g., the arbitrary scaling factor s) of the aforementioned at least one output image with respect to the aforementioned at least one input image, such as the ratio of the resolution of the aforementioned at least one output image to the resolution of the aforementioned at least one input image, may be an arbitrary-scale such as a real-number scale. For better comprehension, the HR image I^{HR}∈R^{sH×sW×3} and the LR image I^{LR}∈R^{H×W×3} may be taken as examples of the aforementioned at least one output image and the aforementioned at least one input image, respectively, and the selected scale may represent the arbitrary scaling factor s such as the ratio s of the resolution sH×SW of the HR image I^{HR}∈R^{sH×sW×3} to the resolution H×W of the LR image I^{LR}∈R^{H×W×3}. The “3” in the respective superscripts “sH×sW×3” and “H×W×3” of “R^{sH×sW×3}” and “R^{H×W×3}” as shown above may indicate that the channel count of multiple channels such as the red (R), the green (G) and the blue (B) color channels of the images are equal to three, but the present invention is not limited thereto. According to some embodiments, the multiple channels of the images and/or the channel count thereof may vary.

More particularly, the arbitrary-scale may be equal to a real number that is greater than one. For example, the electronic device 400 (or the processing circuit 410) may select one of multiple predetermined scales falling within the range of the interval (1, ∞) to be the selected scale, for performing the arbitrary-scale image super-resolution with the trained model to generate the aforementioned at least one output image, where the multiple predetermined scales may comprise a first predetermined scale such as 1.00 . . . 01 (e.g., 1.000001), having a predetermined digit count depending on the maximum calculation capability of the processing circuit 410, and further comprise multiple other predetermined scales such as 2.73 and 7.16 (or “2.73×” and “7.16×” as shown in FIG. 1, respectively, for better comprehension) as well as 1.3, 1.7, 2.2, 2.8, 3.5, 4.3, etc. (or “1.3×”, “1.7×”, “2.2×”, “2.8×”, “3.5×”, “4.3×”, etc., respectively), but the present invention is not limited thereto. In some examples, the multiple predetermined scales may comprise various values that are greater than one.

In Step S12, during performing the arbitrary-scale image super-resolution with the trained model, the processing circuit 410 (or the LINF framework 100 running thereon) may perform prediction processing to obtain multiple super-resolution predictions for different locations (e.g., the locations of the local coordinates input into the multiplier module 114) of a predetermined space (e.g., the space of the aforementioned at least one input image) in a situation where a same non-super-resolution input image (e.g., a same LR input image such as the LR image I^{LR}(1)∈R^{H×W×3}) among the aforementioned at least one input image is given, in order to generate the aforementioned at least one output image.

When there is a need, the processing circuit 410 (or the LINF framework 100 running thereon) may change a controllable super-resolution preference coefficient of the LINF framework 100, such as the temperature coefficient t of the trained model, to perform the arbitrary-scale image super-resolution with the trained model according to the aforementioned at least one input image to generate at least one other output image, where the output images such as the aforementioned at least one output image in Steps S11 and S12 and the aforementioned at least one other output image may be super-resolution results of different preferences produced with a signal model which is the trained model. For example, the selected scale (e.g., the arbitrary scaling factor s) of the aforementioned at least one other output image with respect to the aforementioned at least one input image, such as the ratio of the resolution of the aforementioned at least one other output image to the aforementioned at least one input image, may still be the arbitrary-scale such as the real-number scale (for example, a number with floating or a scale rather than any integer scale), but the present invention is not limited thereto. For another example, the selected scale of the aforementioned at least one output image in Steps S11 and S12 with respect to the aforementioned at least one input image may represent a first selected scale (e.g., the arbitrary scaling factor s=s(1)), and the selected scale of the aforementioned at least one other output image with respect to the aforementioned at least one input image may represent a second selected scale (e.g., the arbitrary scaling factor s=s(2)).

As discussed in some embodiments described above, the LINF framework 100 may be arranged to reconstruct at least one high-resolution (HR) image (e.g., the HR image I^{HR}∈R^{sH×sW×3}) from at least one low-resolution (LR) counterpart (e.g., the LR image I^{LR}∈R^{H×W×3}) by recovering missing high-frequency information. For example, the aforementioned at least one output image (e.g., the HR image I^{HR}(1)∈R^{sH×sW×3}) in Steps S11 and S12 and the aforementioned at least one other output image (e.g., the HR image I^{HR}(2)∈R^{sH×sW×3}) may belong to the aforementioned at least one HR image (e.g., the HR image I^{HR}∈R^{sH×sW×3}), and the aforementioned at least one input image (e.g., the LR image I^{LR}(1)∈R^{H×W×3}) may belong to the aforementioned at least one LR counterpart (e.g., the LR image I^{LR}∈R^{H×W×3}), but the present invention is not limited thereto. In addition, the LINF framework 100 may be arranged to perform the arbitrary-scale image super-resolution with the trained model, without any restriction of not further adjusting output resolutions after any upsampling scale (e.g., the arbitrary scaling factor s) is determined. More particularly, after the selected scale (e.g., the arbitrary scaling factor s) is determined, the LINF framework 100 may perform the arbitrary-scale image super-resolution with the trained model to generate any output image in any step among Steps S11 and S12, and more particularly, when there is a need, adjust the output resolutions of the output images to be generated.

Regarding the training and the inference phases mentioned above, the LINF framework 100 may perform the training of the trained model in the training phase, and perform the arbitrary-scale image super-resolution with the trained model in the inference phase. In the training phase, the LINF framework 100 may formulate super-resolution as the problem of learning the distribution of the local texture patch. In the inference phase, with the learned distribution, the LINF framework 100 may perform the arbitrary-scale image super-resolution with the trained model by generating at least one local texture separately for each non-overlapping patch in any output image among the aforementioned at least one output image in Steps S11 and S12 and the aforementioned at least one other output image. More particularly, the LINF framework 100 may perform the training of the trained model to complete learning at least one distribution (e.g., one or more distributions) of at least one local texture patch (e.g., one or more local texture patches) in the training phase, for performing the arbitrary-scale image super-resolution with the trained model to obtain the multiple super-resolution predictions for the aforementioned different locations of the predetermined space in the inference phase, in order to generate the aforementioned at least one output image.

In addition, the LINF framework 100 may comprise the multiple modules corresponding to the aforementioned different types of models, such as the local implicit module 110 and the coordinate conditional normalizing flow 120, where the local implicit module 110 may comprise the multiple sub-modules mentioned above, and the multiple sub-modules of the local implicit module 110 may comprise a set of first sub-modules for performing the frequency estimation mentioned above, and further comprise at least one second sub-module (e.g., one or more second sub-modules) for performing Fourier analysis. The LINF framework 100 may utilize the set of first sub-modules and the aforementioned at least one second sub-module to perform the frequency estimation and the Fourier analysis, respectively, in order to retain more image details (e.g., high frequency details) during learning the aforementioned at least one distribution of the aforementioned at least one local texture patch in the training phase, for being used in the inference phase. As shown in FIG. 2, the set of first sub-modules may comprise at least one encoder module (e.g., one or more encoder modules) such as the encoder module 111, multiple convolutional layers modules such as the convolutional layers modules 112 and 113, at least one multiplier module (e.g., one or more multiplier modules) such as the multiplier module 114, and at least one linear module (e.g., one or more linear modules) such as the linear module 115, and the aforementioned at least one second sub-module may comprise the Fourier feature formation and ensemble module 116. Based on the architecture shown in FIG. 2, the LINF framework 100 may perform patch-based distribution learning during performing the training of the trained model in the training phase, and perform patch-based inference during performing the arbitrary-scale image super-resolution with the trained model in the inference phase. For brevity, similar descriptions for this embodiment are not repeated in detail here.

For better comprehension, the method may be illustrated with the working flow shown in FIG. 5, but the present invention is not limited thereto. According to some embodiments, one or more steps may be added, deleted, or changed in the working flow shown in FIG. 5. For example, after the associated processing of Steps S11 and S12 in a current iteration of the working flow shown in FIG. 5 is completed, when in Step S11 is re-entered in another iteration, the processing circuit 410 may selectively change the controllable super-resolution preference coefficient (e.g., the temperature coefficient τ) to perform the arbitrary-scale image super-resolution with the trained model according to the aforementioned at least one input image, for generating the aforementioned at least one other output image to be the latest output image of the other iteration, where the processing circuit 410 may change the controllable super-resolution preference coefficient when executing Steps S11 and S12 in a first iteration, and may skip changing the controllable super-resolution preference coefficient when executing Steps S11 and S12 in a second iteration. For brevity, similar descriptions for these embodiments are not repeated in detail here.

According to some embodiments, when there is a need, the processing circuit 410 may update the aforementioned at least one input image in order to perform the associated processing of Steps S11 and S12 according to the updated input image such as the LR image I^{LR}(2)∈R^{H×W×3}, which may still belong to the aforementioned at least one LR counterpart (e.g., the LR image I^{LR}∈R^{H×W×3}), for example, in response to a user input of the user of the electronic device 400. For brevity, similar descriptions for these embodiments are not repeated in detail here.

According to some embodiments, the aforementioned at least one input image (e.g., the LR image I^{LR}(1)∈R^{H×W×3}) used for generating the at least one other output image may be replaced with at least one other input image (e.g., the LR image I^{LR}(2)∈R^{H×W×3}), which may still belong to the aforementioned at least one LR counterpart (e.g., the LR image I^{LR}∈R^{H×W×3}). For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of local implicit normalizing flow for arbitrary-scale image super-resolution, the method being applied to a processing circuit within an electronic device, the method comprising:
utilizing the processing circuit to run a local implicit normalizing flow framework to start performing arbitrary-scale image super-resolution with a trained model of the local implicit normalizing flow framework according to at least one input image, for generating at least one output image, wherein a selected scale of the at least one output image with respect to the at least one input image is an arbitrary-scale; and
during performing the arbitrary-scale image super-resolution with the trained model, performing prediction processing to obtain multiple super-resolution predictions for different locations of a predetermined space in a situation where a same non-super-resolution input image among the at least one input image is given, in order to generate the at least one output image.

2. The method of claim 1, further comprising:
changing a controllable super-resolution preference coefficient of the local implicit normalizing flow framework to perform the arbitrary-scale image super-resolution with the trained model according to the at least one input image to generate at least one other output image, wherein said at least one output image and said at least one other output image are super-resolution results of different preferences produced with a signal model which is the trained model.

3. The method of claim 2, wherein the controllable super-resolution preference coefficient represents a temperature coefficient t of the trained model.

4. The method of claim 1, wherein the local implicit normalizing flow framework is arranged to reconstruct at least one high-resolution (HR) image from at least one low-resolution (LR) counterpart by recovering missing high-frequency information, wherein the at least one output image belongs to the at least one HR image, and the at least one input image belongs to the at least one LR counterpart.

5. The method of claim 1, wherein the local implicit normalizing flow framework is arranged to perform the arbitrary-scale image super-resolution with the trained model, without any restriction of not further adjusting output resolutions after any upsampling scale is determined.

6. The method of claim 1, wherein the local implicit normalizing flow framework is arranged to perform training of the trained model in a training phase, and perform the arbitrary-scale image super-resolution with the trained model in an inference phase.

7. The method of claim 6, wherein in the training phase, the local implicit normalizing flow framework is arranged to formulate super-resolution as a problem of learning a distribution of a local texture patch.

8. The method of claim 7, wherein in the inference phase, with the learned distribution, the local implicit normalizing flow framework is arranged to perform the arbitrary-scale image super-resolution with the trained model by generating at least one local texture separately for each non-overlapping patch in any output image among the at least one output image.

9. The method of claim 6, wherein the local implicit normalizing flow framework is arranged to perform the training of the trained model to complete learning at least one distribution of at least one local texture patch in the training phase, for performing the arbitrary-scale image super-resolution with the trained model to obtain the multiple super-resolution predictions for said different locations of the predetermined space in the inference phase, in order to generate the at least one output image.

10. The method of claim 6, wherein the local implicit normalizing flow framework comprises multiple modules corresponding to different types of models, and the multiple modules corresponding to said different types of models comprise a local implicit module and a coordinate conditional normalizing flow, wherein the local implicit module comprises multiple sub-modules, and the multiple sub-modules of the local implicit module comprise a set of first sub-modules for performing frequency estimation, and at least one second sub-module for performing Fourier analysis; and the local implicit normalizing flow framework is arranged to utilize the set of first sub-modules and the at least one second sub-module to perform the frequency estimation and the Fourier analysis, respectively, in order to retain more image details during learning at least one distribution of at least one local texture patch in the training phase, for being used in the inference phase.

11. The method of claim 10, wherein the set of first sub-modules comprise at least one encoder module, multiple convolutional layers modules, at least one multiplier module and at least one linear module, and the at least one second sub-module comprises a Fourier feature formation and ensemble module.

12. The method of claim 6, wherein the local implicit normalizing flow framework is arranged to perform patch-based distribution learning during performing the training of the trained model in the training phase, and perform patch-based inference during performing the arbitrary-scale image super-resolution with the trained model in the inference phase.

13. An apparatus that operates according to the method of claim 1, wherein the apparatus comprises at least the processing circuit within the electronic device.
